(19) United States
(12) Patent Application Publication
(10) Pub. No.: US 2024/0086845 A1
(43) Pub. Date: Mar. 14, 2024

(54) SYSTEMS AND METHODS FOR FACILITATING COLLABORATION AND INTEGRATION ACROSS CUSTOMER RELATIONSHIP MANAGEMENT INSTANCES

(71) Applicant: JPMORGAN CHASE BANK, N.A., New York, NY (US)

(72) Inventor: Bhavin J. SHUKLA, Piscataway, NJ (US)

(21) Appl. No.: 18/180,737

(22) Filed: Mar. 8, 2023

Related U.S. Application Data
(60) Provisional application No. 63/375,021, filed on Sep. 8, 2022.

(51) Int. Cl. G06Q 10/101

(52) U.S. Cl. CPC G06Q 10/101

(57) ABSTRACT

Systems and methods for facilitating collaboration and integration across customer relationship management (CRM) instances are disclosed. According to one embodiment, a method for facilitating collaboration and integration across customer relationship management instances may include: (1) receiving, at a collaboration and integration platform and from a CRM program instance for a user executed on a user electronic device, an identification of a collaboration between a plurality of users on an out-of-band collaboration network to subscribe to, the collaboration involving a client, a prospective client, or a project; (2) subscribing, by the collaboration and integration platform, the user to the collaboration on the out-of-band collaboration network; (3) receiving, by the collaboration and integration platform and from the out-of-band collaboration network, a message for the subscribed collaboration; and (4) communicating, by the collaboration and integration platform, the message to a CRM program network.

### RELATED APPLICATIONS

This application claims priority to, and the benefit of, U.S. Provisional Patent Application Ser. No. 63/375,021, filed Sep. 8, 2022, the disclosure of which is hereby incorporated, by reference, in its entirety.

### BACKGROUND OF THE INVENTION

### 1. Field of the Invention

Embodiments relate to systems and methods for facilitating collaboration and integration across customer relationship management instances.

### 2. Description of the Related Art

Within an organization, cross line of business (LOB) collaboration is often an ad hoc, non-standardized affair. In general, a combination of communication methods and mechanisms are leveraged, including in person discourse, telephone calls, SMS, video conferences, sticky note passing, emails, instant messages, etc. Due to this, the resulting collaboration cannot be reviewed, evaluated, referenced, searched, or used for coaching. Finally, the collaboration is often disconnected from the CRM, meaning it often lacks context and cannot be incorporated into future customer interactions, evaluations, or assignments.

### SUMMARY OF THE INVENTION

Systems and methods for facilitating collaboration and integration across customer relationship management (CRM) instances are disclosed. According to one embodiment, a method for facilitating collaboration and integration across customer relationship management instances may include: (1) receiving, at a collaboration and integration platform and from a CRM program instance for a user executed on a user electronic device, an identification of a collaboration between a plurality of users on an out-of-band collaboration network to subscribe to, the collaboration involving a client, a prospective client, or a project; (2) subscribing, by the collaboration and integration platform, the user to the collaboration on the out-of-band collaboration network; (3) receiving, by the collaboration and integration platform and from the out-of-band collaboration network, a message for the subscribed collaboration; and (4) communicating, by the collaboration and integration platform, the message to a CRM program network.

In one embodiment, the collaboration may be associated with a collaboration identifier, and the collaboration and integration platform associates the plurality of users, the client, the prospective client, or the project with the collaboration identifier.

In one embodiment, the collaboration may include a plurality of messages between the plurality of users over the out-of-band collaboration network.

In one embodiment, the collaboration integration tool provides a messaging address to the out-of-band collaboration network and receives the message at the messaging address.

In one embodiment, the collaboration and integration platform identifies the subscribed collaboration based on a collaboration identifier associated with the message.

In one embodiment, the CRM program network may be configured to enrich the message, and the method may also include: receiving, by the collaboration and integration platform the enriched message; and communicating, by the collaboration and integration platform, the enriched message to the out-of-band collaboration network, wherein the out-of-band collaboration network communicates the enriched message to the plurality of users.

In one embodiment, the collaboration and integration platform identifies the collaboration by using machine learning based on prior collaborations.

According to another embodiment, a system may include: an in-band customer relationship management (CRM) network; an out-of-band collaboration network; a collaboration and integration platform in communication with the in-band CRM network and the out-of-band collaboration network; and a plurality of user electronic devices, each user electronic device executing a CRM program instance and a collaboration application, wherein the CRM program instance communicates with the in-band CRM network and the collaboration application communicates with the out-of-band collaboration network. The collaboration and integration platform receives an identification of a collaboration between a plurality of users on the out-of-band collaboration network to subscribe to from one of the CRM program instances, the collaboration involving a client, a prospective client, or a project, subscribes the user to the collaboration on the out-of-band collaboration network, receives a message for the subscribed collaboration from the out-of-band collaboration network, and communicates the message to the CRM program network.

In one embodiment, the collaboration may be associated with a collaboration identifier, and the collaboration and integration platform associates the plurality of users, the client, the prospective client, or the project with the collaboration identifier.

In one embodiment, the collaboration may include a plurality of messages between the plurality of users over the out-of-band collaboration network.

In one embodiment, the collaboration and integration platform provides a messaging address to the out-of-band collaboration network and receives the message at the messaging address.

In one embodiment, the collaboration and integration platform identifies the subscribed collaboration based on a collaboration identifier associated with the message.

In one embodiment, the CRM program network enriches the message, the collaboration and integration platform receives the enriched message and communicates the enriched message to the out-of-band collaboration network, and the out-of-band collaboration network communicates the enriched message to the plurality of users.

In one embodiment, the collaboration and integration platform identifies the collaboration by using machine learning based on prior collaborations.

According to another embodiment, a non-transitory computer readable storage medium, may include instructions stored thereon, which when read and executed by one or more computer processors, cause the one or more computer processors to perform steps including: receiving an identification of a collaboration between a plurality of users on an out-of-band collaboration network to subscribe to from a customer relationship management (CRM) instance for a user executed on a user electronic device, the collaboration involving a client, a prospective client, or a project; subscribing the user to the collaboration on the out-of-band collaboration network; receiving a message for the subscribed collaboration from the out-of-band collaboration network; and communicating the message to a CRM program network.

In one embodiment, the collaboration may be associated with a collaboration identifier, and further including instructions stored thereon, which when read and executed by one or more computer processors, cause the one or more computer processors to associate the plurality of users, the client, the prospective client, or the project with the collaboration identifier.

In one embodiment, the collaboration may include a plurality of messages between the plurality of users over the out-of-band collaboration network.

In one embodiment, the non-transitory computer readable storage medium may also include instructions stored thereon, which when read and executed by one or more computer processors, cause the one or more computer processors to provide a messaging address to the out-of-band collaboration network and receives the message at the messaging address.

In one embodiment, the non-transitory computer readable storage medium may also include instructions stored thereon, which when read and executed by one or more computer processors, cause the one or more computer processors to identify the subscribed collaboration based on a collaboration identifier associated with the message.

In one embodiment, the CRM program network may be configured to enrich the message, and the non-transitory computer readable storage medium may also include instructions stored thereon, which when read and executed by one or more computer processors, cause the one or more computer processors to perform steps comprising: receiving the enriched message; and communicating the enriched message to the out-of-band collaboration network, wherein the out-of-band collaboration network communicates the enriched message to the plurality of users.

According to another embodiment, a method may include: receiving, at a hub instance of the customer relationship management instances and from an electronic device for a first line of business, a referral request; creating, by the hub, the referral; programmatically creating, by the hub, a collaborative tool communication channel for the referral; creating, by the hub, a strategic partner record linking for the referral, wherein the strategic partner record linking identifies the first line of business, a contact at the first line of business, a referee, and the collaborative tool communication channel; creating and assigning, by the hub, the referral to an electronic device for a second line of business; receiving, by the hub, acceptance of the referral from the electronic device for the second line of business; and updating, by the hub, the strategic partner record.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for facilitating collaboration and integration across customer relationship management instances according to an embodiment;

FIG. 2 illustrates a method for facilitating collaboration and integration across customer relationship management instances according to an embodiment;

FIG. 3 depicts an exemplary data record according to an embodiment; and

FIG. 4 depicts an exemplary computing system for implementing aspects of the present disclosure.

### DETAILED DESCRIPTION OF PREFERRED EMBODIMENTS

Embodiments relate to systems and methods for facilitating collaboration and integration across instances of customer relationship management (CRM) programs. An out-of-band collaboration network may provide a communication channel to facilitate the collaboration.

Non-limiting examples of CRM programs include Hubspot, Mailchimp, Salesforce, ZohoCRM, etc., and non-limiting examples of out-of-band collaboration networks include Skype, Symphony, SMS Messaging, Slack, WhatsApp, etc. Other CRMs and collaboration tools may be used as is necessary and/or desired.

In facilitating cross LOB collaboration, embodiments may not interfere with the LOB specific activities. Thus, embodiments may provide an ancillary solution to the CRM program instance, and may be neither a replacement nor a component of the CRM program instance. Further, embodiments may include security that provides selective visibility to only specifically designated parties, such as the referring individual from the initial LOB, the designated individual from the second LOB, etc.

Embodiments may provide bi-directional integration between the out-of-band collaboration network and the CRM program instance. This may facilitate real-time collaboration as well as workflow and appropriate data visibility, thereby maximizing user impact and optimizing real-time collaboration regardless of which system is presently in use.

The CRM program instance may provide an open API foundation that exposes API that enable the necessary communication between the CRM program instance and the out-of-band collaboration network. A single CRM program instance, however, is likely to be insufficient for multiple LOB business, process, security, and visibility needs. In the case of complex organizations, multiple lines of business may share a customer. Consequently, a multi-CRM program instance strategy that connects multiple lines of business (LOBs) may be provided, such that the customer data can be shared/accessed among these LOBs.

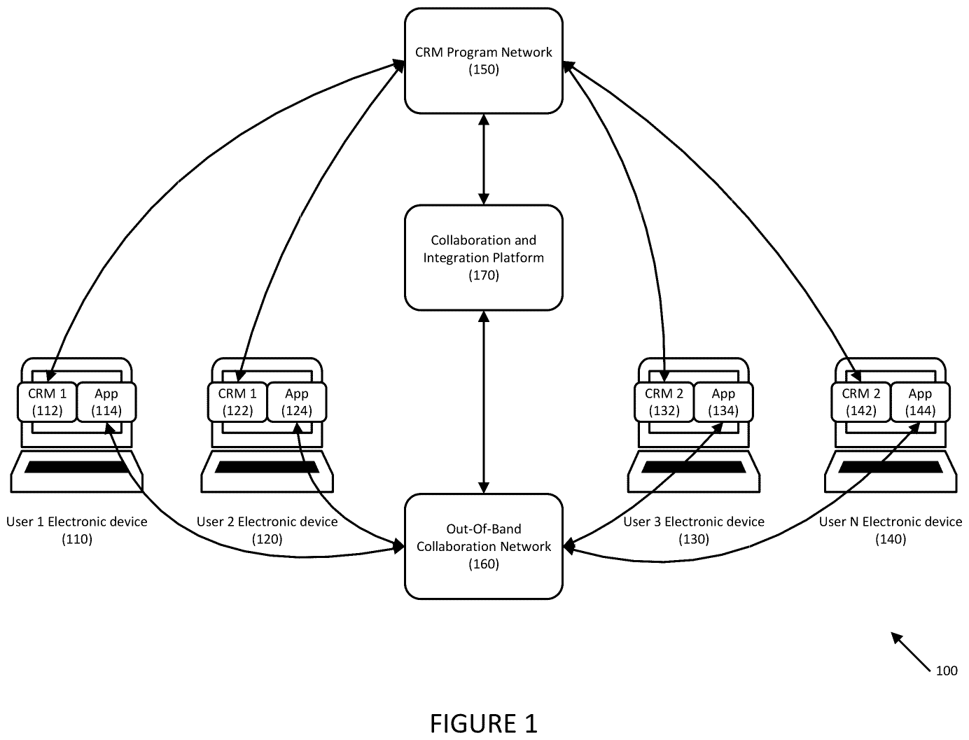

Referring to FIG. 1, a system for facilitating collaboration and integration across customer relationship management instances is disclosed according to an embodiment. System 100 may include a plurality of user electronic devices (e.g., user 1 electronic device 110, user 2 electronic device 120, user 3 electronic device 130, user N electronic device 140). User electronic devices 110, 120, 130, 140 may be any suitable electronic device, including computers (e.g., workstations, desktops, laptops, notebooks, tablets, etc.), smartphones, Internet of Things (IoT) appliances, etc.

Although four user electronic devices are depicted, it should be recognized that additional or fewer user electronic devices may be provided as is necessary and/or desired. For example, there may be hundreds or even thousands of users using each CRM program instance on their electronic devices for their job-function responsibilities.

Each user electronic device 110, 120, 130, 140 may execute a CRM program instance (e.g., CRM 1 instance 112, CRM 1 instance 122, CRM 2 instance 132, CRM 2 instance 142, etc.) of a CRM program. Each CRM program instance may communicate in-band CRM activity with each other over CRM program network 150.

CRM program network 150 may connect CRM program instances (e.g., CRM 1 instance 112, CRM 1 instance 122, CRM 2 instance 132, CRM 2 instance 142, etc.) and may include the CRM program (not shown).

It should be noted that multiple CRM programs may be used (e.g., CRM 1, CRM 2, etc.) and user electronic devices 110, 120, 130, 140 may support more than one CRM program type.

Each user electronic device 110, 120, 130, 140 may also execute collaborative app (e.g., app 114, app 124, app 134, app 144, etc.) Each collaborative app 114, 124, 134, 144 may provide an interface to out-of-band collaboration network 160, and may allow the users to communicate over out-of-band collaboration network 160.

CRM program network 150 may interface with out-of-band collaboration network 160 using collaboration and integration platform 170. For example, using collaboration and integration platform 170, a user CRM program instance may subscribe to a collaboration (e.g., messages between two or more users, documents, notes, etc.) that may be related to the users, to a client, to a prospective client, to a project common to a plurality of users, etc. over out-of-band collaboration network 160, and may then receive messages and other communications related to the collaboration. Out-of-band collaboration network 160 may provide the messages to CRM program network 150 for a CRM program, which may then associate the messages with the appropriate user, client, project, etc. The out-of-band collaboration network may be created, maintained, purged and archived programmatically and without any manual intervention.

A project may be any task on which one or more user is working.

In one embodiment, machine learning and/or artificial intelligence may be used to identify collaborations to which a user CRM program instance should subscribe, and to present those to the user. For example, using historical data, a trained machine learning engine may predict and suggest collaborations to which a user CRM program instance should subscribe without requiring. Machine learning models may also be used to govern the duration for which the collaboration channels shall exist.

In one embodiment, after receiving a collaboration message, a CRM program instance may enrich the collaboration message with CRM insights, and may send a subsequent message to out-of-band collaboration network 160 for distribution to the users participating the in collaboration.

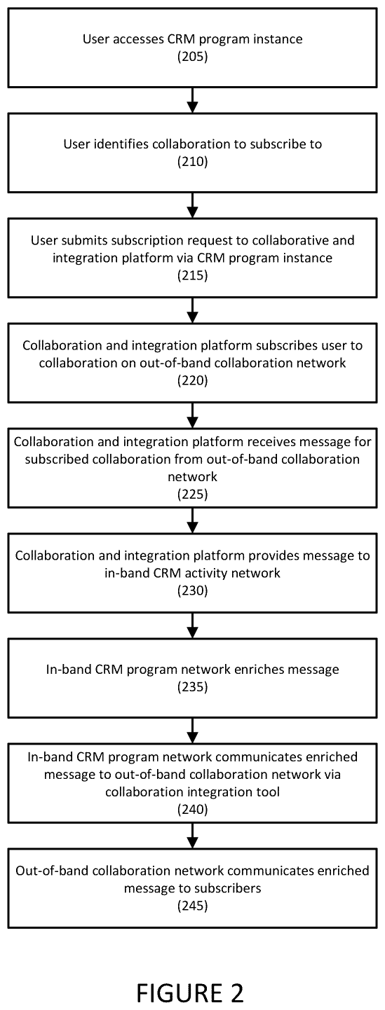

Referring to FIG. 2, a method for facilitating collaboration and integration across customer relationship management instances is disclosed according to an embodiment.

In step 205, a user may access a CRM program instance. For example, the user may access a CRM program instance on the user's electronic device.

In step 210, the user may identify a collaboration, such as messages between users, documents, notes, etc. on an out-of-band collaboration network to subscribe to. For example, the user may identify another user, a client, a prospective client, a project, etc. and may request that the user subscribe to communications related to that collaboration. In one embodiment, the user may already be involved in the collaboration and may seek to link the collaboration to the user, client, prospective client, and/or project in the CRM program instance. Thus, the user may provide a collaboration identifier for the collaboration used by the out-of-band collaboration network to subscribe to the collaboration.

The collaboration identifier may uniquely identify the collaboration, and may be included in the messages, documents, and other communications. The collaboration identifier may be a number, a hexadecimal number, an alphanumeric code, or any other mechanism that may uniquely identify the collaboration.

In one embodiment, machine learning and/or artificial intelligence may be used to suggest collaborations for the user to subscribe to. For example, a machine learning engine, neural network, etc. may be trained on prior collaborations involving the user, other users, the project or a similar project, the client, etc.

In step 215 the user may submit a subscription request to subscribe to the collaboration. The user may submit the request to the collaboration and integration platform via the CRM program instance. Alternately, the user may submit a request via the out-of-band collaboration network to add a collaboration to the CRM activity.

In step 220, the collaboration integration tool may automatically subscribe to the collaboration on the out-of-band collaboration network. In one embodiment, the collaboration integration tool may provide a messaging address (e.g., email, text, etc.) that the collaboration tool may forward messages for subscribed collaborations to.

The automatic linking to the collaboration may provide full visibility and transparency and may provide and maximize a 360 degree view of the prospect or the client that two or more users are collaborating over.

In one embodiment, the collaboration integration tool may associate a collaboration identifier for the collaboration with the user(s), the client, the prospective client, and/or the project in the CRM program instance.

In step 225, the collaboration integration tool may receive a message for a subscribed collaboration from the out-of-band collaboration network. For example, the collaboration integration tool may monitor the out-of-band collaboration network for messages involving subscribed collaborations, or the out-of-band collaboration network may forward messages involving subscribed collaborations to the collaboration integration tool.

In one embodiment, the message may include or be associated with a collaboration identifier, and the collaboration integration tool may use the collaboration identifier to identify the user(s), the client, the prospective client, and/or the project for the collaboration.

In step 230, the collaboration integration tool may provide the message to a CRM program network. The collaboration integration tool may use the collaboration identifier to route the message to the appropriate users.

In step 235, the CRM program network may enrich message with, for example, data about the client, potential client, project, other subscribes to the collaboration, etc. Examples include demographics data, recent changes to the goals, upcoming events, any automatic rebalancing of the account, recent securities transactions, any public news or government regulations that can potentially impact this client or prospect, other CRM program instances involved, etc.

In step 240, the CRM program network may communicate the enriched message to the out-of-band collaboration network via the collaboration integration tool. For example, artificial intelligence model of regression may be used to predict and suggest the next best suggestion for a client or prospect. The CRM program network may suggest workflow tasks for the user(s), which may save time.

In another embodiment, a clustering model may be used to analyze the variety and veracity of tasks performed for a given client, potential client, or project in order to identify efficiencies. A trained machine learning engine may receive the in-band (e.g., CRM) activity and the out-of-band communications and may use supervised and unsupervised learning to train the machine learning engine to identify and recommend efficiencies to the user(s).

In one embodiment, artificial intelligence (e.g., natural language generation techniques) may be used to convert machine-generated events into user-friendly messages that are published to the collaboration tool for easy consumption. For example, if a status for the subject of the channel is undergoing changes, various systems will generate encoded events. These events may be converted into user-friendly messages that may be posted on the subscribed collaboration tool communication channel.

In step 245, the out-of-band collaboration network may communicate the enriched message to subscribers of the collaboration.

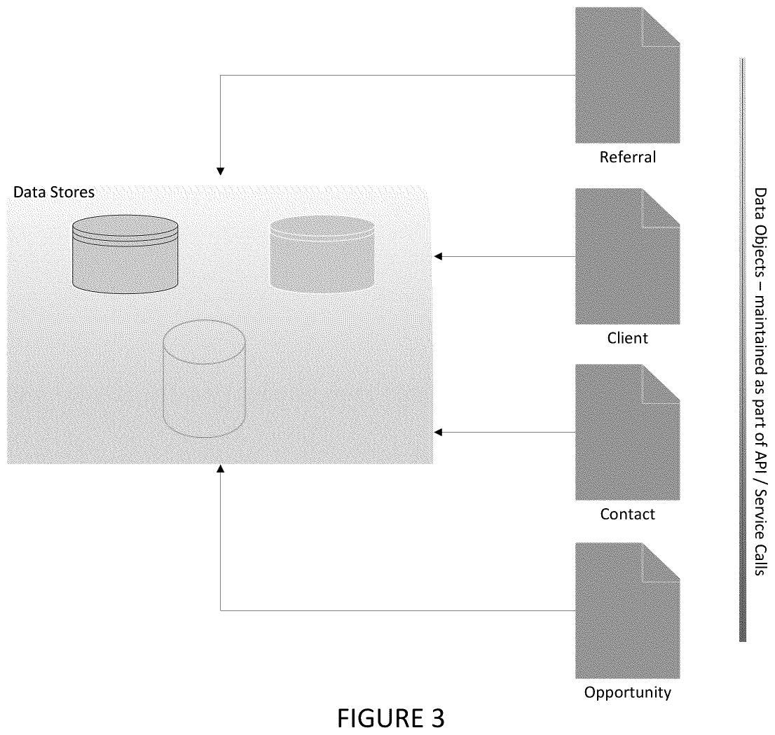

An example of a data model is provided in FIG. 3. The data model joins the referral record, which models the potential opportunity (e.g., a mortgage), the client, and two employees that work in separate business units, or lines of business (“LOBs”). Additionally, the junction object stores the name of the collaboration tool communication channel, allowing for reference.

The referral generation, routing, assigning, and acceptance process may be as seamless as possible. The referral itself may not require user input, as the details of the referral such as the client, nature of their need, timing, etc. may be specified by the referring employee.

In embodiments, the creation, maintenance, and clean-up of the collaboration tool communication channel, as well as the inclusion of the two users from separate LOBs to collaborate, may be automated using an API provided by the collaboration tool.

In embodiments, the collaboration tool communication channels may be created programmatically and not manually. Programmatic creation and decommissioning of such communication channels may permit the creation of real-time relationships as needed. Further, the programmatic creation ensures the automatic inclusion and availability of the collaboration tool communication channels, which in turn encourages adoption. The use of the CRM program instance with the collaboration tool provides optionality for how work is initiated, acted on, and collaborated around. As a result, if a user is using a native CRM ecosystem, activity on the related communication channels may be incorporated directly into the collaboration tool.

If the user is using the collaboration tool application, the user may peruse through integrated activities across all communication channels that the user is part of. Any active contribution on those communication channels can automatically be visible across the collaboration tool and the CRM program instance, if so desired.

In addition, because collaboration tools often support multiple collaboration types (beyond just text-based messaging), they may be used to initiate and continue many workflows. For example, organizations often have complex workflows that employees heavily rely on. Such workflows may be integrated as part of activity right within the collaboration tool communication channels and they may be acted upon irrespective of the ecosystem the user is part of—the CRM program instance or the collaboration tool.

Embodiments may support multiple CRM implementation solutions along with multiple collaboration implementations. Embodiments may leverage open architecture standards such as API and messaging, multiple CRM implementations, multiple versions of CRM implementations, etc. to achieve collaboration.

Due to the nature of the design and open architecture, embodiments may support peer-to-peer collaboration models without requiring a hub. Often times to support a client or a prospect, multiple lines of businesses across an organization come together. This is an example of peer-to-peer collaboration. In embodiments, a collaboration channel may be created for a client/prospect that may be used as the “glue” to facilitate collaboration across multiple CRM program instances as well as out-of-band communication on a collaboration channel.

Because both the CRM program instances and the collaboration tools often support a mobile responsive experience, the collaboration described above may be achieved across web and mobile form factors.

Embodiments may leave the CRM program instances supporting multiple lines of businesses separate and distinct.

Embodiments may programmatically create communication channels that provide messaging layer across instances.

Embodiments may provide a sophisticated user-experience that surfaces those messages.

Embodiments may enable communication to take place within the context of a client and within CRM program instances as well as out-of-band outside the CRM program instances, but still contextual.

Embodiments provide the flexibility to have a private, secure and compliant messaging solution that provides an underlying communication protocol as well as a user-experience layer.

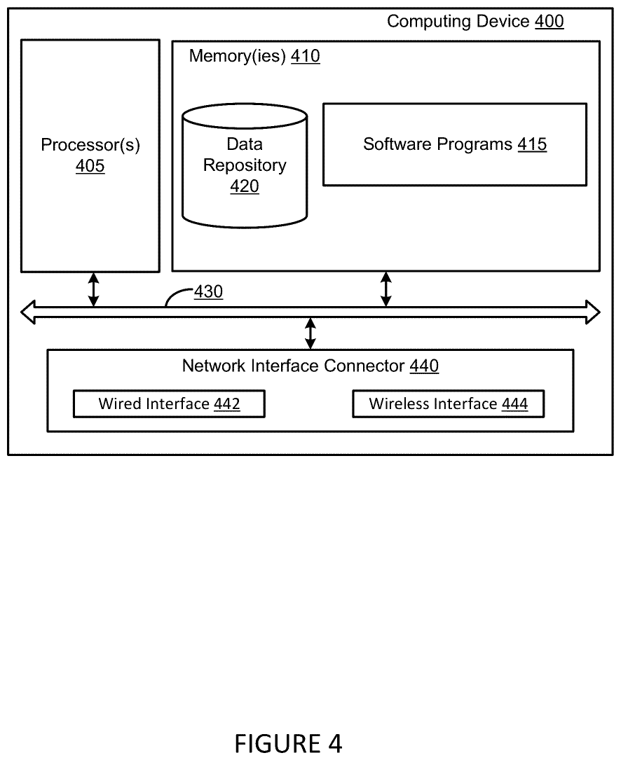

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for facilitating collaboration and integration across customer relationship management (CRM) program instances, comprising:
receiving, at a collaboration and integration platform and from a CRM program instance for a user executed on a user electronic device, an identification of a collaboration between a plurality of users on an out-of-band collaboration network, the collaboration involving a client, a prospective client, or a project;
subscribing, by the collaboration and integration platform, the user to the collaboration on the out-of-band collaboration network;
receiving, by the collaboration and integration platform and from the out-of-band collaboration network, a message for the subscribed collaboration; and
communicating, by the collaboration and integration platform, the message to a CRM program network.

2. The method of claim 1, wherein the collaboration is associated with a collaboration identifier, and the collaboration and integration platform associates the plurality of users, the client, the prospective client, or the project with the collaboration identifier.

3. The method of claim 1, wherein the collaboration comprises a plurality of messages between the plurality of users over the out-of-band collaboration network.

4. The method of claim 1, wherein the collaboration integration tool provides a messaging address to the out-of-band collaboration network and receives the message at the messaging address.

5. The method of claim 1, wherein the collaboration and integration platform identifies the subscribed collaboration based on a collaboration identifier associated with the message.

6. The method of claim 1, wherein the CRM in-band activity network is configured to enrich the message, and further comprising:
receiving, by the collaboration and integration platform the enriched message; and
communicating, by the collaboration and integration platform, the enriched message to the out-of-band collaboration network, wherein the out-of-band collaboration network communicates the enriched message to the plurality of users.

7. The method of claim 1, wherein the collaboration and integration platform identifies the collaboration by using machine learning based on prior collaborations.

8. A system, comprising:
an in-band customer relationship management (CRM) network;
an out-of-band collaboration network;
a collaboration and integration platform in communication with the in-band CRM network and the out-of-band collaboration network; and
a plurality of user electronic devices, each user electronic device executing a CRM program instance and a collaboration application, wherein the CRM program instance communicates with the in-band CRM network and the collaboration application communicates with the out-of-band collaboration network;
wherein:
the collaboration and integration platform receives an identification of a collaboration between a plurality of users on the out-of-band collaboration network to subscribe to from one of the CRM program instances, the collaboration involving a client, a prospective client, or a project;
the collaboration and integration platform subscribes the user to the collaboration on the out-of-band collaboration network;
the collaboration and integration platform receives a message for the subscribed collaboration from the out-of-band collaboration network; and
the collaboration and integration platform communicates the message to the CRM program network.

9. The system of claim 8, wherein the collaboration is associated with a collaboration identifier, and the collaboration and integration platform associates the plurality of users, the client, the prospective client, or the project with the collaboration identifier.

10. The system of claim 8, wherein the collaboration comprises a plurality of messages between the plurality of users over the out-of-band collaboration network.

11. The system of claim 8, wherein the collaboration and integration platform provides a messaging address to the out-of-band collaboration network and receives the message at the messaging address.

12. The system of claim 8, wherein the collaboration and integration platform identifies the subscribed collaboration based on a collaboration identifier associated with the message.

13. The system of claim 8, wherein the CRM program network enriches the message, the collaboration and integration platform receives the enriched message and communicates the enriched message to the out-of-band collaboration network, and the out-of-band collaboration network communicates the enriched message to the plurality of users.

14. The system of claim 8, wherein the collaboration and integration platform identifies the collaboration by using machine learning based on prior collaborations.

15. A non-transitory computer readable storage medium, including instructions stored thereon, which when read and executed by one or more computer processors, cause the one or more computer processors to perform steps comprising:
receiving an identification of a collaboration between a plurality of users on an out-of-band collaboration network to subscribe to from a customer relationship management (CRM) instance for a user executed on a user electronic device, the collaboration involving a client, a prospective client, or a project;
subscribing the user to the collaboration on the out-of-band collaboration network;
receiving a message for the subscribed collaboration from the out-of-band collaboration network; and
communicating the message to a CRM program network.

16. The non-transitory computer readable storage medium of claim 15, wherein the collaboration is associated with a collaboration identifier, and further including instructions stored thereon, which when read and executed by one or more computer processors, cause the one or more computer processors to associate the plurality of users, the client, the prospective client, or the project with the collaboration identifier.

17. The non-transitory computer readable storage medium of claim 15, wherein the collaboration comprises a plurality of messages between the plurality of users over the out-of-band collaboration network.

18. The non-transitory computer readable storage medium of claim 15, further including instructions stored thereon, which when read and executed by one or more computer processors, cause the one or more computer processors to provide a messaging address to the out-of-band collaboration network and receives the message at the messaging address.

19. The non-transitory computer readable storage medium of claim 15, further including instructions stored thereon, which when read and executed by one or more computer processors, cause the one or more computer processors to identify the subscribed collaboration based on a collaboration identifier associated with the message.

20. The non-transitory computer readable storage medium of claim 15, wherein the CRM program network is configured to enrich the message, and further including instructions stored thereon, which when read and executed by one or more computer processors, cause the one or more computer processors to perform steps comprising:
receiving the enriched message; and
communicating the enriched message to the out-of-band collaboration network, wherein the out-of-band collaboration network communicates the enriched message to the plurality of users.
